(19) United States
(12) Patent Application Publication
(10) Pub. No.: US 2007/0182943 A1
(43) Pub. Date: Aug. 9, 2007

(54) Debris apparatus, system, and method

(76) Inventor: Francis Goodwin, Halfmoon, NY (US)

Correspondence Address: SLATER & MATSIL LLP, 17950 PRESTON ROAD, SUITE 1000, DALLAS, TX, 75252, US

(21) Appl. No.: 11/347,867

(22) Filed: Feb. 6, 2006

(51) Int. Cl. G03B 27/42

(52) U.S. Cl. 355/53; 355/30

(57) ABSTRACT

Apparatus, system, and method for reducing contamination of semiconductor device wafers in immersion lithography fabrication. A preferred embodiment comprises a support ring to provide structural integrity to the apparatus and a planar ring formed on one side of the support ring. The planar ring has a plurality of openings formed through the planar ring. The apparatus is placed into a trench of a wafer stage and the openings permit excess immersion fluid to pass through, into the trench, where it can be removed. However, the apparatus prevents the excess immersion fluid and contaminants from within the trench from being drawn back onto the wafer stage by the motion of the wafer stage, potentially contaminating a semiconductor wafer.

### TECHNICAL FIELD

The present invention relates generally to an apparatus, a system, and a method for semiconductor device fabrication, and more particularly to an apparatus, a system, and a method for reducing the contamination of semiconductor device wafers in immersion lithography fabrication.

### BACKGROUND

There is a continuous push to develop semiconductor device fabrication techniques and technologies that can resolve smaller and smaller feature sizes. Standard optical lithography techniques cannot resolve feature sizes that are desired today. The exotic lithography techniques such as extreme ultraviolet lithography that can resolve the desired feature sizes, would require the investment of billions of dollars to develop new fabrication equipment and processes.

Fortunately, the discovery of immersion lithography fabrication techniques has enabled the semiconductor device manufacturers to resolve feature sizes that were heretofore impossible using existing optical lithography fabrication equipment and processes. Immersion lithography involves the placement of a liquid, such as water, between the imaging equipment and the semiconductor device wafer to support the increase of the numerical aperture of the imaging system, for example, to values greater than one. The increase in the numerical aperture of the imaging system to values above one has enabled the resolution of smaller feature sizes.

With reference now to FIGS. 1a and 1b, there are shown diagrams illustrating a cross-sectional view of a portion of a semiconductor device fabrication system 100 and a top view of a wafer stage, wherein both are used in the immersion lithography fabrication of semiconductor devices. The diagram shown in FIG. 1a illustrates a portion of the semiconductor device fabrication system 100, including a projection lens of an imaging system 110. As discussed above, immersion lithography uses an immersion fluid 105, such as water, placed between the projection lens of an imaging system 110 and a wafer 115 to support the increase of the numerical aperture of the projection lens of an imaging system 110 to above one and increase the ability of the imaging system 100 to resolve smaller feature sizes. The imaging system 110 exposes a pattern onto a resist layer 120 on top of the wafer 15. The wafer 115 can be attached to a wafer stage 125, which can be used to enable the fixing of the wafer 115 to the semiconductor device fabrication system 100 as well as enable the moving of the wafer 115 under the projection lens of an imaging system 110.

The wafer stage 125 comprises an exposure chuck 130 that can be used to attach the wafer 115 to the wafer stage 125 as well as a trench 135 around the periphery of the exposure chuck 130. The trench 135 can permit removal of excess immersion fluid 105 which may escape from containment under the projection lens of the imaging system 110 or removal of immersion fluid 105 which may drain off of the wafer 115 and/or the wafer stage 125. Drain hole(s) 140 in the trench 135 can permit the removal of accumulated immersion fluid 105. The projection lens of an imaging system 110 may comprise a bottom lens element 145 and a bottom plate 150 to help protect the bottom lens element 145 from contamination by the immersion fluid 105. The diagram shown in FIG. 1b illustrates a top view of the wafer stage 125 showing the exposure chuck 130 and the trench 135.

One disadvantage of the prior art is that the movement of the wafer stage 125, under the projection lens of an imaging system 110, can result in the movement of contaminants from the wafer stage 125 and/or trench 135 onto the wafer 115 and hence, the resist layer 120. The contaminants from the wafer stage 125 and/or trench 135 can be carried onto the wafer 115 by the immersion fluid 105. The contaminants, such as impurities in the immersion fluid 105, various residue on the wafer stage 125, and so on, can result in a damaged semiconductor device and therefore, reduce the overall yield of the immersion lithography fabrication system.

### SUMMARY OF THE INVENTION

These and other problems are generally solved or circumvented, and technical advantages are generally achieved, by preferred embodiments of the present invention which provides an apparatus, a system, and a method for reducing the contamination of semiconductor device wafers in immersion lithography fabrication.

In accordance with a preferred embodiment of the present invention, an apparatus is provided. The apparatus is used in a circular trench of a wafer stage to permit excess immersion fluid used in immersion lithography to pass from an imaging system into the circular trench. The apparatus includes a support ring to provide structural integrity to the apparatus and a planar ring formed on one side of the support ring. The planar ring has a plurality of openings formed through the planar ring that permit the immersion fluid to pass through the apparatus.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1a and 1b are diagrams of a cross-sectional view of a portion of an immersion lithography semiconductor device fabrication system and a top view of a wafer stage;

FIGS. 2a and 2b are diagrams showing the movement of contaminants onto a surface of a wafer from the movement of the wafer;

FIGS. 3a and 3b are diagrams of a top view of a debris ring and a side view of a portion of the debris ring, according to a preferred embodiment of the present invention;

FIGS. 4a and 4b are diagrams of the debris ring in operation, according to a preferred embodiment of the present invention;

FIGS. 5a through 5c are diagrams of exemplary debris rings, according to a preferred embodiment of the present invention;

FIGS. 6a and 6b are diagrams of a top view of a debris ring and a cross-sectional view of the debris ring, according to a preferred embodiment of the present invention;

FIGS. 7a and 7b are diagrams of the debris ring in operation, according to a preferred embodiment of the present invention;

FIGS. 8a through 8c are diagrams of exemplary debris rings, according to a preferred embodiment of the present invention; and

FIG. 9 is a diagram of a sequence of events in the fabrication of a semiconductor device, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely an immersion lithography fabrication system wherein the motion of a wafer stage under an imaging system can help to draw immersion fluid containing contaminants from a trench onto a surface of a wafer. The invention may also be applied, however, to other fabrication systems wherein the motion of a wafer stage can induce a vacuum that can draw contaminants onto the surface of a wafer.

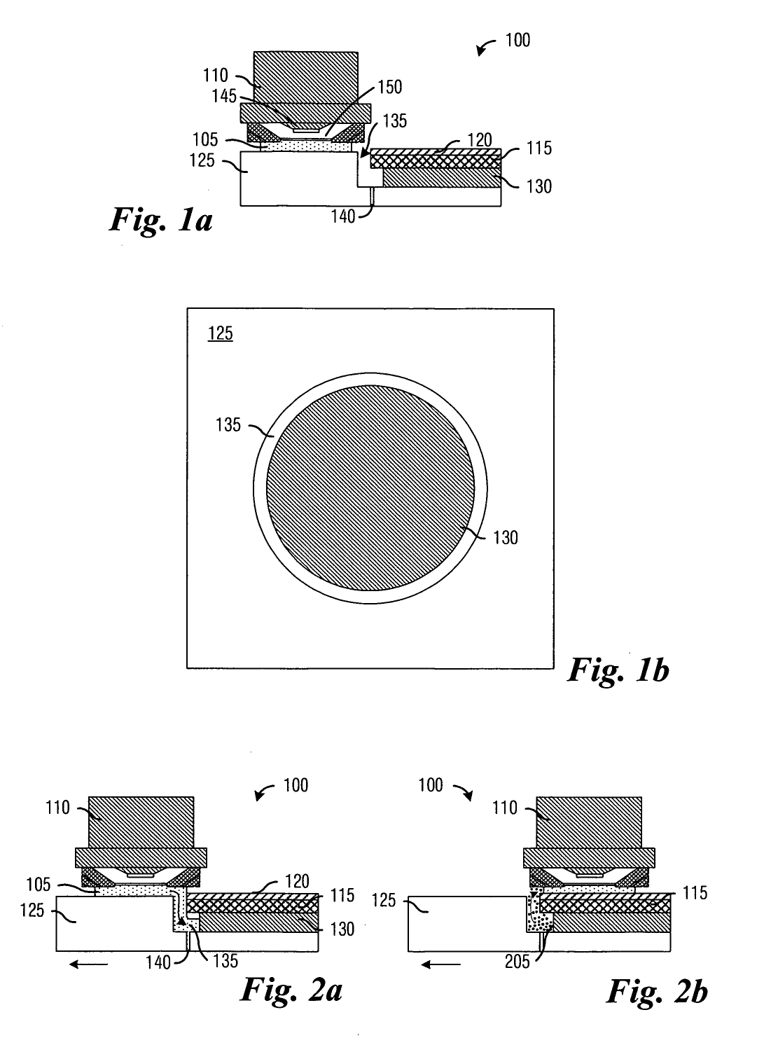

With reference now to FIGS. 2a and 2b, there are shown diagrams illustrating the movement of contaminants onto a surface of a wafer as a result of movement of the wafer in a semiconductor device fabrication system 100. The diagram shown in FIG. 2a illustrates a portion of the semiconductor device fabrication system 100, wherein the wafer stage 125 is moving in a right-to-left direction underneath the projection lens of an imaging system 110, which is typically held in a fixed position. Mounted on the wafer stage 125 via the exposure chuck 130 is the wafer 115. The wafer 115 has a layer of resist 120 on its surface.

As the wafer stage 125 moves in the right-to-left direction, the trench 135 comes under the projection lens of an imaging system 110 of the semiconductor device fabrication system 100 and the immersion fluid 105. Some of the immersion fluid 105 enters the trench 135, with the drain hole 140 evacuating at least a portion of the immersion fluid 105. Along with the immersion fluid 105, which can itself contain some contaminants such as particles of impurities, dissolved minerals, and so forth, contaminants from the wafer stage 125 can also be carried by the immersion fluid 105 into the trench 135.

The diagram shown in FIG. 2b illustrates a portion of the semiconductor device fabrication system 100, wherein the wafer stage 125 is further along in its motion in a right-to-left direction underneath the projection lens of the imaging system 110 and the wafer 115 is partially underneath the projection lens of the imaging system 110. As shown in FIG. 2b, the projection lens of the imaging system 110 is almost entirely lying over the wafer 115. The motion of the wafer stage 125 underneath the projection lens of the imaging system 110 can create a vacuum that can draw some immersion fluid 205 that entered the trench 135 back onto the wafer 115. However, since the drain hole 140 has removed some of the immersion fluid 205, the immersion fluid 205 drawn back onto the wafer 115 is likely to have a greater concentration of impurities and contaminants than the immersion fluid 105 that entered the trench 135. The impurities and contaminants in the immersion fluid 205 can cause problems in subsequent fabrication process steps, such as contamination of the wafer surface, and result in the fabrication of faulty semiconductor devices.

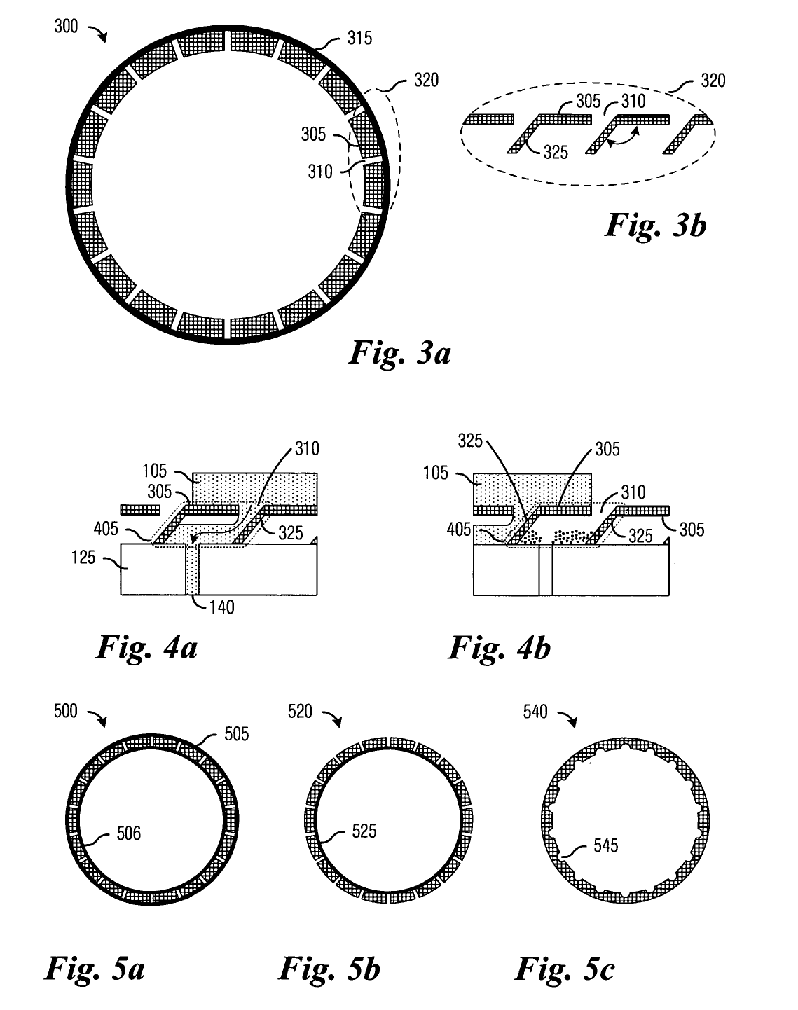

With reference now to FIGS. 3a and 3b, there are shown diagrams illustrating a top view and a side view of a portion of a debris ring 300 for use in reducing the introduction of contaminants onto a wafer surface by immersion fluid drawn from a trench, according to a preferred embodiment of the present invention. The diagram shown in FIG. 3a illustrates a top view of the debris ring 300 that can be inserted into the trench 135 of the wafer stage 125 (both of FIG. 1b) with the debris ring 300 resting fully inside the trench 135 so that it would not interfere with the movement of the wafer stage 125 as it travels underneath the projection lens of the imaging system 110 (FIG. 1a) nor would the debris ring 300 interfere with the attachment of the wafer 115 onto the expansion chuck 130. The debris ring 300 can be formed from a wide variety of materials that repel, do not combine with, do not dissolve in, and so forth, the immersion fluid 105. Such materials are referred to as being hydrophobic. For example, if the immersion fluid 105 is water, then the debris ring 300 can be made from teflon, a teflon impregnated material, or a teflon coated material. If the immersion fluid 105 is a liquid other than water, the debris ring 300 may be made of a material other than teflon.

The debris ring 300 comprises a plurality of segments, such as segment 305, separated by slots, such as slot 310. An outer edge of the segments 305 fits against a wall of the trench 135 on a first side and an inner edge of the segments 305 fits against a wall of the expansion chuck 130 on a second side, forming a tight seal. The slots 310 permit the immersion fluid 105 to drain into the trench 135 when a portion of the trench 135 is underneath the imaging system 110. The debris ring 300 also comprises a support ring 315 that provides support for the segments 305, keeps the segments 305 together as a single unit, and helps to keep the segments 305 in place as the debris ring 300 is being inserted into the trench 135, removed from the trench 135, and while in use. The support ring 315 helps to maintain the structural integrity of the debris ring 300. The support ring 315 can be in the form of a cylindrical wall that is as high as the debris ring 300 itself, or the support ring 315 can be a portion of the height of the debris ring 300 in height.

The diagram shown in FIG. 3b illustrates a side view of a portion of the debris ring 300, such as what is highlighted by a dashed oval 320 in FIG. 3a. The side view of a portion of the debris ring 300 shown in FIG. 3b does not illustrate the support ring 315 in order to provide a clear view of the structure of the debris ring 300. The diagram shown in FIG. 3b illustrates the segments 305 of the debris ring 300 separated by slots 310. Also shown are flanges attached to the segment 305, such as flange 325. The flange 325 is attached to one end of the segment 305 and is angled in a downward direction towards the bottom of the trench 135. The flange 325 should be of adequate length so that the extension 325 will make contact with the bottom of the trench 135 when the debris ring 300 is inserted into the trench 135.

The angle of the flange 325 in relation to the segment 305 should be sufficiently acute so that the flange 325 is not overly long with respect to the length of the segment. For example, if the angle is approximately 90 degrees, the length of the flange 325 is substantially equal to a distance that the segment 305 is above the bottom of the trench 135, while if the angle is larger, for example, 135 degrees, then the length of the flange 325 is approximately 1.44* (distance that the segment 305 is above the bottom of the trench 135), where 1.44 is the absolute value of the inverse of the cosine of 135 degrees. The angle of flange 325 should be large enough to place a bottom edge of the flange 325 underneath an edge of a segment adjacent to the segment 305 but not so large that it blocks the drain hole 140.

The slots 310 can play an important role in the ability of the debris ring 300 to remove immersion fluid 105 that enters the trench 135. If the width of the slots 310 is relatively large with respect to the size of the segments 305, then the immersion fluid 105 that enters the trench 135 can easily pass through the debris ring 300. However, if the width of the slots 310 is too large, it will be easier for the immersion fluid 105 that has passed through the debris ring 300 to be drawn back onto the wafer stage 125 and/or the wafer 115. If the width of the slots 310 is too small, then it may not be possible to remove the immersion fluid 105 entering the trench 135 at a sufficient rate. In addition to the width of the slots 310, the number of slots 310 in the debris ring 300 can also have an effect on the effectiveness of the debris ring 300. The number and the size of the slots 310 for a given debris ring 300 can differ based upon factors such as the flow of the immersion fluid 105, the size of the trench 135, the size and number of drain holes 140, and so forth.

With reference now to FIGS. 4a and 4b, there are shown diagrams illustrating the debris ring 300 in operation, according to a preferred embodiment of the present invention. The diagrams shown in FIGS. 4a and 4b illustrate a portion of a side view of the trench 135 of a wafer stage 125 with the debris ring 300 inserted into the trench 135. The diagrams shown in FIGS. 4a and 4b illustrate the operation of the debris ring 300 in permitting immersion fluid 105 as well as impurities and contaminants entering the trench 135 to be evacuated, by a drain hole 140, for example, while preventing immersion fluid and impurities/contaminants from being drawn back out of the trench 135. The diagram shown in FIG. 4a illustrates an instance in time where the immersion fluid 105 passes through the slot 310 and enters a chamber 405 created by the flanges 325 of the debris ring 300. The drain hole 140 allows the immersion fluid 105 to evacuate the chamber 405. Negative pressure (suction), applied via the drain hole 140 can expedite the evacuation of the immersion fluid 105 from the chamber 405.

The diagram shown in FIG. 4b illustrates an instance in time shortly after the instance in time shown in the diagram shown in FIG. 4a, wherein the wafer stage 125 has moved slightly and the projection lens of the imaging system 110 (not shown) and the immersion fluid 105 is no longer directly over the slot 310 and the chamber 405 as shown in FIG. 4a. As discussed previously, without the debris ring 300 in place in the trench 135, as the projection lens of the imaging system 110 (not shown) and the immersion fluid 105 moves away from the slot 310, due to the movement of the wafer stage 125, it is possible for any remaining immersion fluid 105 as well as impurities and contaminants in the trench 135 to be drawn back onto the surface of the wafer stage 125 and the wafer 115. However, the chamber 405 created by the segments 305 and the flanges 325 can prevent the immersion fluid 105 and impurities and contaminants from being drawn back onto the surface of the wafer stage 125 and the wafer 115.

Although shown in FIGS. 4a and 4b as being oriented along a direction of movement of the wafer stage 125, the flanges 325 can retain their effectiveness in helping to prevent the drawing of the immersion fluid 105 back from the trench 135 even if the orientation of the flanges 325 was opposite of the direction of movement of the wafer stage 125. The presence of the flanges 325 effectively partitions the trench 135 into a multitude of individual chambers that can help compartmentalize the trench 135.

With reference now to FIGS. 5a through 5c, there are shown diagrams illustrating exemplary debris rings, according to a preferred embodiment of the present invention. The diagram shown in FIG. 5a illustrates an exemplary debris ring 500, wherein there is an outer support ring 505 and an inner support ring 506. The diagram shown in FIG. 5b illustrates an exemplary debris ring 520, wherein there is an inner support ring 525. The diagram shown in FIG. 5c illustrates an exemplary debris ring 540, wherein the debris ring 540 features perforations, such as perforation 545, arranged about an inner edge of the debris ring 540 instead of slots. The perforations 545 permit the immersion fluid 105 that has entered the trench 135 to pass through the debris ring 540. The debris ring 540 can still have flanges 325 on an underside (not shown in the diagram) that can form chambers to help prevent the immersion fluid 105 that has entered the trench 135 from being drawn back onto the surface of the wafer stage 125 and/or the wafer 115. Although shown to be arranged along the inner edge of the debris ring 540, the perforations 545 can be placed at a variety of positions throughout the surface of the debris ring 540. Additionally, alternate embodiments of the debris ring 540 can have support rings at an inner edge or an outer edge or both the inner edge and the outer edge of the debris ring 540.

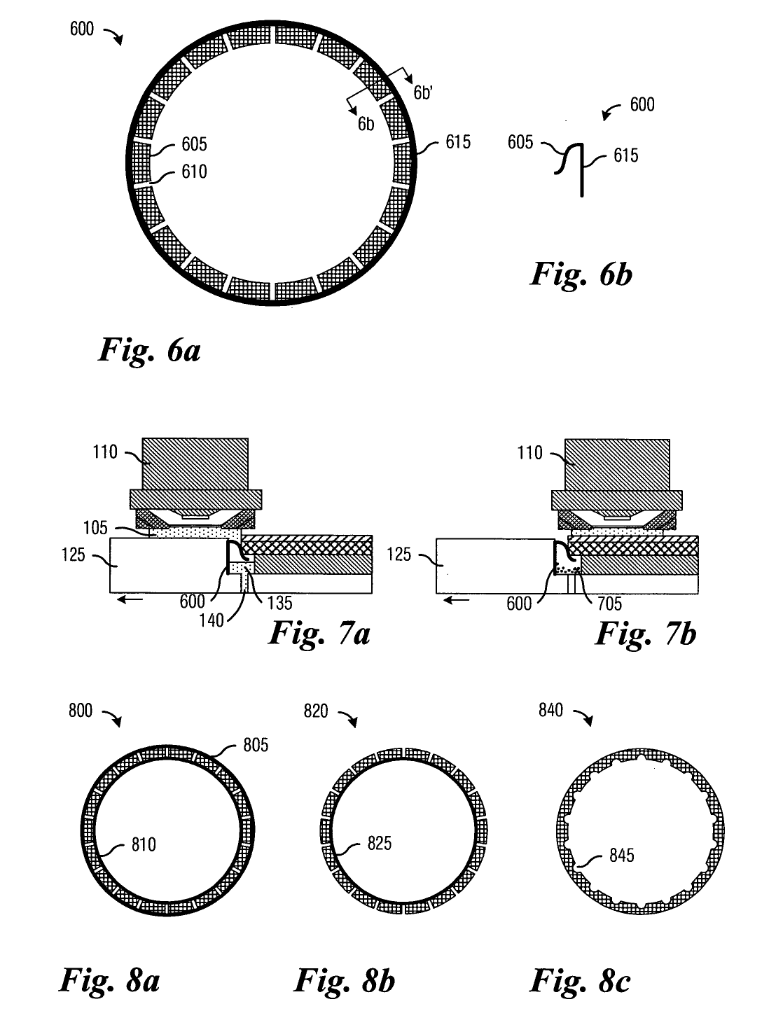

With reference now to FIGS. 6a and 6b, there are shown diagrams illustrating a top view and a cross-sectional view of a portion of a debris ring 600 for use in reducing the introduction of contaminants onto a wafer surface by immersion fluid drawn from a trench, according to a preferred embodiment of the present invention. The diagram shown in FIG. 6a illustrates a top view of the debris ring 600 that can be inserted into the trench 135 of the wafer stage 125 (both of FIG. 1b) with the debris ring 600 resting inside the trench 135 so that it would not interfere with the movement of the wafer stage 125 as it travels underneath the projection lens of the imaging system 110 (FIG. 1a) nor would the debris ring 600 interfere with the attachment of the wafer 115 onto the expansion chuck 130. The debris ring 600 can be formed from a wide variety of materials that repel, do not combine with, do not dissolve in, and so forth, the immersion fluid 105. Such materials are referred to as being hydrophobic. For example, if the immersion fluid 105 is water, then the debris ring 600 can be made from teflon, a teflon impregnated material, or a teflon coated material. If the immersion fluid 105 is a liquid other than water, the debris ring 600 may be made of a material other than teflon.

The debris ring 600 comprises a plurality of segments, such as segment 605, separated by slots, such as slot 610. An outer edge of the segments 605 fits against a wall of the trench 135 on a first side and a part of a top surface of the segments 605 fits against an edge of the wafer 115 on a second side and forms a tight seal. The slots 610 permit the immersion fluid 105 to drain into the trench 135 when a portion of the trench 135 is underneath the imaging system 110. The debris ring 600 also comprises a support ring 615 that provides support for the segments 605, keeps the segments 605 together as a single unit, and helps to keep the segments 605 in place as the debris ring 600 is being inserted into the trench 135, removed from the trench 135, and while in use. The support ring 615 can be in the form of a wall that is as high as the debris ring 600 itself, or the support ring 615 can be a portion of the height of the debris ring 600 in height.

The diagram shown in FIG. 6b illustrates a view of a cross-section of the debris ring 600, as viewed through a slice cut through the debris ring 600 along line 6b-6b′. The cross-section of the debris ring 600 illustrates the structure of the debris ring 600 comprising the support ring 615 and the segments 605. As shown in FIG. 6a, the support ring 615 would rest against a wall of the trench 135 while the segments 605 would rest against an edge of the wafer 115. The segments 605 can be flanges extending from the support ring 615. The segments 605 can be made from a material with a flexible consistency, and therefore having a spring-like effect when compressed against the edge of the wafer 115 resting against it. The spring-like effect of the segments 605 can help to improve a seal between the debris ring 600 and the wafer 115. Although shown in FIG. 6b as having a compound curve, alternate embodiments of the segments 605 may have a simple curve, a stepped edge to hold the wafer 115, or may even be flat. Alternatively, the debris ring 600 may fit in the trench 135, completely under the wafer 115, so that the wafer 115 does not come into contact with the debris ring 600. In this case, the segments 605 can come into contact with a first wall of the trench 135 opposite a second wall of the trench 135 making contact with the support ring 615.

With reference now to FIGS. 7a and 7b, there are shown diagrams illustrating the debris ring 600 in operation, according to a preferred embodiment of the present invention. The diagrams shown in FIGS. 7a and 7b illustrate a cross-section view of a portion of a semiconductor device fabrication system with the debris ring 600 inserted into the trench 135. The diagram shown in FIG. 7a illustrates an instance in time where the wafer stage 125 is moving in a right-to-left direction and the projection lens of the imaging system 110 is just starting to impinge over the wafer 115. The immersion fluid 105 is starting to spill into the trench 135, where the debris ring 600 permits the immersion fluid 105 to enter the trench 135. The immersion fluid 105 can pass through the slots 610 on the debris ring 600. Once the immersion fluid 105 enters the trench 135, the drain hole 140 can evacuate the immersion fluid 105.

The diagram shown in FIG. 6b illustrates an instance in time shortly after the instance in time shown in the diagram shown in FIG. 6a, wherein the wafer stage 125 has moved slightly and the projection lens of the imaging system 110 and the immersion fluid 105 is no longer directly over the trench 135. The presence of the debris ring 600 prevents the movement of the wafer stage 125 underneath the projection lens of the imaging system 110 from drawing any immersion fluid 105 from the trench 135 back onto the wafer stage 125 or the wafer 115. The diagram also shows impurities 705 (and contaminants) from the immersion fluid 105 after the immersion fluid 105 has been removed from the trench by the drain hole 140.

With reference now to FIGS. 8a through 8c, there are shown diagrams illustrating exemplary debris rings, according to a preferred embodiment of the present invention. The diagram shown in FIG. 8a illustrates an exemplary debris ring 800, wherein there is an outer support ring 805 and an inner support ring 810. The diagram shown in FIG. 8b illustrates an exemplary debris ring 820, wherein there is an inner support ring 825. The diagram shown in FIG. 8c illustrates an exemplary debris ring 840, wherein the debris ring 840 features perforations, such as perforation 845, arranged about an inner edge of the debris ring 840 instead of slots. Although shown to be arranged along the inner edge of the debris ring 840, the perforations 845 can be placed at a variety of positions throughout the surface of the debris ring 840. Additionally, alternate embodiments of the debris ring 840 can have support rings at an inner edge or an outer edge or both the inner edge and the outer edge of the debris ring 840.

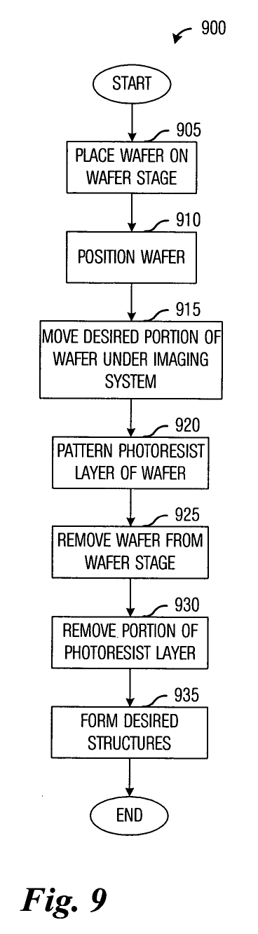

With reference now to FIG. 9, there is shown a diagram illustrating a sequence of events 900 in the fabrication of a semiconductor device, wherein the fabrication makes use of immersion lithography, according to a preferred embodiment of the present invention. The sequence of events 900 display the creation of a single layer of structures on a semiconductor wafer, such as a metal layer, a poly layer, and so on. The sequence of events 900 can begin with the placement of a wafer 115 on a wafer stage 125 (block 905). According to a preferred embodiment of the present invention, the wafer stage 125 comprises an exposure chuck 130 and a trench 135 (all of FIG. 1b). The exposure chuck 130 can be used to hold the wafer 115 in position while the wafer stage 125 moves the wafer 115 under an imaging system. The trench 135, which surrounds the exposure chuck 130 and the wafer 115 when it is in the exposure chuck 130, will permit excess immersion fluid 105 to be evacuated. The wafer stage 125 also comprises a debris ring, such as debris ring 300, 500, 520, 540, 600, 800, 820, 840, or some other variant, that is inserted into the trench 135. As discussed above, a debris ring, for example, debris ring 300, can permit the excess immersion fluid 105 to enter the trench 135 but help prevent the excess immersion fluid 105 from being drawn back onto the wafer stage 125 and/or the wafer 115.

Once the wafer 115 has been placed on the exposure chuck 130 of the wafer stage 125, the wafer 115 can be positioned (block 910). The positioning of the wafer 115 is needed to determine a reference position of the wafer 115 so that it is possible to align a pattern mask and minimize the various layers of the semiconductor device being created on the wafer 115. The positioning of the wafer 115 can be performed using alignment marks located on the wafer 115. The positioning of the wafer 115 can require the movement of the wafer stage 125 under the imaging system. As the wafer stage 125 moves under the imaging system, excess immersion fluid 105 can enter the trench 135 whenever a portion of the trench 135 is underneath the imaging system.

After the positioning of the wafer 115, the wafer 115 can be moved so that the imaging system is positioned above a portion of the wafer 115 that is to be patterned (block 915). A photoresist layer on a top surface of the wafer 115 under the imaging system can be patterned by a light (potentially light that is not in the visible spectrum) with a specific set of optical properties provided by the imaging system (block 920). The portions of the photoresist layer exposed to the light will either be made soluble or insoluble to a basic solution or a solvent while portions not exposed to the light will be unaffected. The patterning of the wafer 115 is repeated for remaining portions of the wafer 115. Once the patterning is complete, the wafer 115 can be removed from the wafer stage 125 (block 925) and the exposed pattern transferred to the wafer by rinsing the wafer with a basic solution or a solvent (block 930). The structures can then be formed on the wafer 115 (block 935) in alignment with the patterned photoresist. For example, conductors can be formed using vapor deposition, dopants can be infused into the wafer, and so forth. Should additional layers be formed on the wafer 115, the processed photoresist can be stripped and a new layer of photoresist can be deposited on the wafer 115 and the sequence of events 900 can be repeated until the semiconductor device is complete. Actual fabrication steps can differ depending upon the fabrication process used and the above discussion is intended to provide a general framework and not to describe an actual fabrication process.

An advantage of a preferred embodiment of the present invention is that the present invention can be used in the semiconductor device fabrication system and can improve the yield of the fabrication process by preventing residue and contaminants from being drawn back onto the operating area of the semiconductor device fabrication system and contaminating the wafer.

A further advantage of a preferred embodiment of the present invention is that the present invention can be used to improve the yield of the fabrication process without requiring any changes to the design of the semiconductor device fabrication system. Therefore, implementation of the of the present invention is fast and does not require any modification to the fabrication process, which may require the expenditure of debugging and testing time.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus for use in a trench system of a wafer stage, the apparatus configured to permit excess fluid used in immersion lithography to pass from an imaging system into the trench system, the apparatus comprising:
a first ring; and
a second ring formed on one side of the first ring, the second ring having a plurality of openings formed through the second ring, wherein the openings permit the excess fluid to pass through the apparatus.

2. The apparatus of claim 1 further comprising a third ring formed on a side of the second ring opposed to the first ring.

3. The apparatus of claim 1, wherein the apparatus is formed from a material that is hydrophobic to the immersion fluid.

4. The apparatus of claim 3, wherein the wherein the immersion fluid comprises water, and wherein the apparatus is formed from a material selected from a group comprising: teflon, teflon impregnated materials, and teflon coated materials.

5. The apparatus of claim 1, wherein the openings are slots formed perpendicular to the first ring, forming a plurality of segments.

6. The apparatus of claim 5, wherein each segment has a flange coupled to a first end of the segment and extending at an angle, downward and away from the segment.

7. The apparatus of claim 6, wherein each flange has sufficient length to make contact with a bottom of the trench system when the apparatus is inserted into the trench system.

8. The apparatus of claim 5, wherein each segment angles downward and away from the second ring, and wherein a lower edge of a wafer held in the wafer stage presses against a top surface of each segment to create a tight seal.

9. The apparatus of claim 5, wherein the segment has a compound curve profile.

10. The apparatus of claim 1, wherein the openings are perforations, and wherein the perforations are formed along an inner edge of the second ring.

11. The apparatus of claim 1, wherein the openings are perforations, and wherein the plurality of perforations is distributed throughout the second ring.

12. A method for fabricating a device using immersion lithography, the method comprising:
positioning a flat disc shaped work piece in a device fabrication system, wherein excess fluid used in immersion lithography can be evacuated from the device fabrication system via a trench system surrounding the flat disc shaped work piece when the trench system is underneath the fluid, the trench system containing a debris ring;
exposing portions of a first layer on the flat disc shaped work piece;
removing the flat disc shaped work piece from the device fabrication system; and
forming structures in a surface of the flat disc shaped work piece in alignment with a pattern exposed on the first layer.

13. The method of claim 12, wherein the debris ring comprises:
a first ring; and
a second ring formed on one side of the first ring, the second ring having a plurality of openings formed through the second ring.

14. The apparatus of claim 13, wherein the openings are slots formed perpendicular to the second ring, forming a plurality of segments, and wherein each segment has a flange coupled to a first end of the segment and extending at an angle, downward and away from the segment.

15. A system comprising:
an imaging system to optically expose a photo-resist layer to a layer pattern, wherein the imaging system uses immersion lithography to expose the photo-resist layer;
a movable stage arranged under the imaging system, the movable stage configured to hold a semiconductor wafer in place and to move the semiconductor wafer to a desired position to be exposed by the imaging system, the movable stage comprising,
a chuck to hold the semiconductor wafer;
a trench formed around the chuck, the trench configured to collect excess immersion fluid used by the imaging system; and
a debris ring placed in between the chuck and the trench, the debris ring to permit the excess immersion fluid to pass through from the imaging system into the trench.

16. The system of claim 15, wherein the movable stage further comprises a plurality of drain holes arranged on a bottom surface of the trench to permit evacuation of the excess immersion fluid.

17. The system of claim 15, wherein the debris ring comprises:
a support ring to provide structural integrity to the apparatus; and
a planar ring formed on one side of the support ring, the planar ring having a plurality of openings formed through the planar ring.

18. The system of claim 17, wherein an inner edge of the debris ring fits against the chuck and an outer edge of the debris ring fits against a wall of the trench, and wherein the excess immersion fluid passes through the openings formed through the planar ring.

19. The system of claim 17, wherein the openings are slots formed perpendicular to the support ring, forming a plurality of segments, and wherein each segment has a flange coupled to a first end of the segment and extending at an angle downward and away from the segment, and wherein the flange prevents the excess immersion fluid from flowing back through the debris ring.

20. The system of claim 17, wherein each segment angles downward and away from the support ring, and wherein a lower edge of the semiconductor wafer presses against a top of each segment to create a tight seal.
